(19) United States
(12) Patent Application Publication
(10) Pub. No.: US 2013/0182411 A1
(43) Pub. Date: Jul. 18, 2013

(54) Tangible navigation of color temperature and light intensity

(71) Applicants: Roel Peter Geert Cuppen, Venlo (NL); Bartel Marinus Van De Sluis, Eindhoven (NL); Angelique Carin Johanna Maria Brosens- Kessels, Eindhoven (NL)

(72) Inventors: Roel Peter Geert Cuppen, Venlo (NL); Bartel Marinus Van De Sluis, Eindhoven (NL); Angelique Carin Johanna Maria Brosens- Kessels, Eindhoven (NL)

(73) Assignee: KONINKLIJKE PHILIPS ELECTRONICS N.V., Eindhoven (NL)

(21) Appl. No.: 13/825,237

(22) PCT Filed: Sep. 19, 2011
(86) PCT No.: PCT/IB2011/054080

§ 371 Date: Mar. 20, 2013

(30) Foreign Application Priority Data
Sep. 24, 2010 (EP) 10179094.7

(51) Int. Cl. H05B 37/02

(52) U.S. Cl. CPC H05B 37/02
USPC 362/85

(57) ABSTRACT

A device (100) for controlling an intensity and a color temperature of light emitted by an adjustable light source is provided. The device resembles the well-known faucet for adjusting the flow and the temperature of water. The device comprises a user-operable handle (101), a lever movement (103, 104) of the handle being associated with the intensity and a rotational movement (105, 106) of the handle being associated with the color temperature, sensor means for sensing a user-set position of the handle, and means for generating, in accordance with the user-set position, a control signal for controlling the intensity and the color temperature of light emitted by the adjustable light source. An embodiment of the invention constitutes a tangible user-interface by providing control means which are well-known to consumers and which are associated with the notion of “cold” and “warm”.

### FIELD OF THE INVENTION

The invention relates in general to the control of artificial lighting, and more specifically to a user interface for controlling adjustable light sources.

### BACKGROUND OF THE INVENTION

Controllable light sources have become increasingly popular in consumer lighting applications. Solid state light (SSL) sources, e.g. LEDs, provide the consumer with artificial light of variable intensity and color temperature.

The notion of color temperature may be used to characterize the emission spectrum of a light source. The color temperature of a light source, which is usually measured in Kelvin, is defined as the temperature of an ideal black-body radiator that radiates light of comparable hue to that of the light source. With increasing temperature of the radiator, its color will change from black (0 K) to red (1000 K), yellow (2500 K), white (4500 K), and eventually to bluish white (>6500 K). Light having a low color temperature is perceived as “warm”, whereas light having a high color temperature is perceived as “cold”.

In consumer lighting systems, a user interface, such as a remote control, is typically used for adjusting certain properties of the light source, such as the emitted light's intensity and its color temperature. However, the acceptance of controllable light sources in consumer lighting applications is hampered by the fact that consumers may not be familiar with the concept of color temperature, i.e. they cannot relate to the term as such or the typical range of values associated with visible light. Furthermore, in current light bulbs, color temperature and intensity are often related. A low intensity renders light having a low color temperature, and a high intensity results in light having a high color temperature. Finally, the fact that light which is perceived as warm has a low color temperature, and vice versa, contributes to the confusion.

WO 2006/129256 discloses a control for an adjustable light source, which control comprises a user-controllable element for adjusting the color temperature of the light source, the user-controllable element being labeled with meteorological symbols commonly associated with the notion of “warm” and “cold”, such as a sun and a cloud, respectively.

### SUMMARY OF THE INVENTION

It is an object of the present invention to provide a more efficient alternative to the above techniques and prior art.

More specifically, it is an object of the present invention to provide a tangible user interface for controlling adjustable light sources.

These and other objects of the present invention are achieved by means of a device having the features defined in independent claim 1, and by means of a device having the features defined in independent claim 8. Embodiments of the invention are characterized by the dependent claims.

According to a first aspect of the invention, a device for controlling an intensity and a color temperature of light emitted by an adjustable light source is provided. The device comprises a user-operable handle, sensor means, and means for generating a control signal. The user-operable handle is maneuverable through a two-dimensional space. A lever movement of the handle is associated with the intensity of light, and the rotational movement of the handle is associated with the color temperature of light. The sensor means is arranged for sensing a position of the handle, which position is set by a user of the device. The means for generating a control signal is arranged for generating a control signal for controlling the intensity and the color temperature of light emitted by the adjustable light source. The control signal is generated in accordance with the user-set position.

According to a second aspect of the invention, a device for controlling an intensity and a color temperature of light emitted by an adjustable light source is provided. The device comprises a user-operable first knob, a user-operable second knob, sensor means, and means for generating a control signal. The sensor means is arranged for sensing a first position of the first knob and a second position of the second knob, which first position and second position are set by a user of the device. The means for generating a control signal is arranged for generating a control signal for controlling the intensity and the color temperature of light emitted by the adjustable light source. The control signal is generated in accordance with the user-set first position and second position, wherein a sum of the first position and the second position is indicative of the desired intensity, and a ratio, or a difference, of the first position and the second position is indicative of the desired color temperature.

For the purpose of describing the present invention, a user-set position is a setting made by a user operating the device for the purpose of adjusting the intensity and/or the color temperature of light emitted by an adjustable light source. A position may, e.g., be expressed as a coordinate, an angle, or as a relative parameter having a value between a minimum and a maximum value. Such a parameter may correspond to a predetermined value range for intensity and color temperature, respectively.

The present invention makes use of an understanding that a tangible user interface for controlling an adjustable light source in consumer lighting applications may be realized by utilizing control means which are well known to consumers and which, moreover, are associated with the notion of “cold” and “warm”.

In particular, this may be achieved by a device according to the first aspect of the invention, which resembles the well known faucet for controlling the flow and the temperature of water, using a single, user-operable, handle. More specifically, the up-and-down movement of the handle may be associated with the intensity of light, whereas the rotational movement of the handle, i.e. left and right, may be associated with the color temperature. By way of such a light faucet, the intensity and the color temperature may be controlled more or less with a single gestural action, thus turning two parameters into only one perceived parameter.

As an alternative, a device according to the second aspect of the invention may be utilized, which resembles a traditional faucet having two knobs, one for controlling the flow of cold water and the other for controlling the flow of warm water. In this case, the intensity and the color temperature may be derived from the user-set positions of both the first and the second knob, after the fashion of a traditional faucet which is used for controlling the flow and the temperature of water by adjusting the flow of cold and warm water separately. More specifically, the light intensity may be derived from a sum of the first and the second position, whereas the color temperature may be derived from a ratio, or a difference, of the first and the second position. More generally, the intensity may also be derived from a conical combination of the first and the second position.

A controlling device according to an embodiment of the invention is advantageous in that it provides an intuitive and recognizable way of controlling the intensity and the color temperature of an adjustable light source, since it is based on the well known way of controlling the flow and the temperature of water by way of a faucet.

Further, a device according to the invention is advantageous in that it is perceived as a natural element in certain consumer lighting applications, in particular bathroom lighting. In other words, a remote control for controlling artificial light in a bathroom is more likely to be accepted if it resembles a faucet instead of a traditional remote control. In addition to harmonizing with the environment, users may feel safer with such a device as compared to a traditional remote control, which may be refused by consumers in moist environments because of safety considerations.

According to an embodiment of the invention, the controlling device further comprises means for transmitting the control signal wirelessly to the light source. Using wireless communication for transmitting the control signal from the controlling device to an adjustable light source is advantageous since no wired means for transmitting the signal, such as wires or optical fibres, are required. The wireless communication may be effected using any wireless technology and may, e.g., be based on radio frequency, infrared light, or coded visible light. However, the control signal may also be transmitted in a wired fashion over wires or optical fibres. As an alternative, the control signal may also be transmitted over an existing power line, and in particular a power line to which the adjustable light source is connected.

According to an embodiment of the invention, the controlling device further comprises means for storing the user-set position, and the means for generating a control signal is further arranged for generating, when the device is activated, a control signal in accordance with the last-stored user-set position. Providing the controlling device with means for storing the last user-set position is advantageous in that well-defined light settings, i.e. the intensity and the color temperature, may be transmitted to the adjustable light source when the controlling device is activated. As an alternative to storing the user-set positions, the device may store values derived from such positions. For instance, the device may store the desired intensity and/or the desired color temperature.

According to an embodiment of the invention, the controlling device further comprises a clock, and the means for generating a control signal is further arranged for generating, when the device is activated, a control signal in accordance with a time of day. Providing the controlling device with a clock is advantageous in that well-defined light settings, i.e. intensity and color temperature, may be transmitted to the adjustable light source when the controlling device is activated. As an example, a “cold” light setting may be used in the morning, and a “warm” light setting may be used in the evening.

According to an embodiment of the invention, the sensor means is arranged for sensing the user-set position using accelerometers. As an alternative, rheostats or potentiometers, or any other type of suitable transducers, may be used.

According to an embodiment of the invention, the controlling device further comprises means for scavenging electrical energy from a movement of the handle or the knobs. This is advantageous in that the power needed for operating the device, i.e. for sensing a user-set position as well as generating and transmitting the control signal, may be extracted from a movement of the handle, or the knobs, performed by the user. In that case, no battery or external power supply is required. At the least, the requirements on a battery or a power supply are lowered. The scavenging means may also be arranged for charging a battery comprised in the controlling device.

According to an embodiment of the invention, the controlling device further comprises a suction cup for attaching the device to a surface. Providing the controlling device with a suction cup is advantageous in that the device can simply be attached to a surface, such as a tile wall in a bathroom, thereby eliminating the need for mounting the device by screws, nails, glue, or the like.

According to an embodiment of the invention, the controlling device further comprises a light sensor for sensing light emitted by the adjustable light source. This is advantageous in that the device may be activated in response to it having determined that the adjustable light source has been switched on. Thereby, the power consumption of the controlling device is reduced. Further, the device may be arranged for determining an identity of the adjustable light source based on light emitted by that light source, which light is sensed using the light sensor. Determining an identity of an adjustable light source is advantageous if the device is used for controlling multiple light sources, in particular using a wireless technique having a range extending outside the room where the controlling device is located. In order to avoid that light sources located in adjacent rooms are controlled accidentally, the device may be arranged to control only light sources which have been identified by way of light emitted by such light sources. Light sources may, e.g., be identified based on coded visible light.

According to an embodiment of the invention, the controlling device is comprised in a lighting system which further comprises a controllable light source. The controllable light source is arranged for receiving a control signal from the device, and adjusting the intensity and the color temperature of emitted light in response to the received control signal.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

The above as well as additional objects, features and advantages of the present invention will be better understood through the following illustrative and non-limiting detailed description of embodiments of the present invention, with reference to the appended drawings, in which:

FIG. 1 is a perspective view of a light faucet according to an embodiment of the invention.

FIG. 2 is a perspective view of a light faucet according to another embodiment of the invention.

FIG. 3 shows a lighting system according to an embodiment of the invention.

All the Figures are schematic, not necessarily to scale, and generally only show parts which are necessary in order to elucidate the invention, wherein other parts may be omitted or merely suggested.

### DETAILED DESCRIPTION

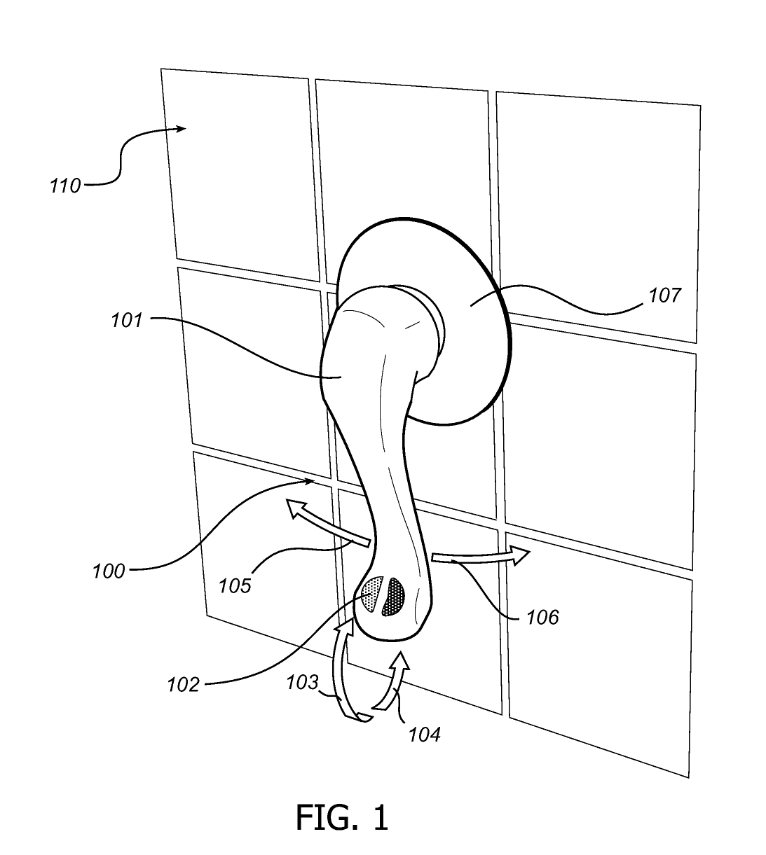

In FIG. 1, a controlling device according to an embodiment of the invention is illustrated.

The controlling device 100, also referred to as a light faucet, comprises a handle 101 for controlling an adjustable light source. The handle 101 may be maneuvered by a user for adjusting properties of light emitted by the light source, in particular the light's intensity and color temperature. When adjusting the intensity and/or the color temperature, the user may perform the well known movements involved in operating a faucet for adjusting the flow and the temperature of water.

More specifically, by pulling the handle 101 upwards 103, the intensity of light is increased, whereas the intensity is decreased by pushing the handle 101 downwards 104. Further, by rotating the handle 101 clockwise 105, the color temperature of light is lowered, such that the emitted light is perceived as being “colder”, whereas the color temperature is raised by rotating the handle 101 counter-clockwise 106, such that the emitted light is perceived as being “warmer”. For the purpose of indicating the relation between the rotational movements, i.e. turning clockwise 105 or counter-clockwise 106, the handle 101 is provided with a label 102, e.g. a red-blue colored label as is frequently found on water faucets.

The light faucet 100 may, as is shown in FIG. 1, be attached to a surface, such as tile wall 110, using a suction cup 107.

Device 100 further comprises means for sensing a position of the handle 101, which position is set by the user, means for generating a control signal, means for transmitting the control signal to a light source, and a power supply, such as a battery or a means for scavenging energy (not shown in FIG. 1). Device 100 may further comprise a light sensor for sensing light emitted by an adjustable light source for the purpose of activating device 100 only when the adjustable light source is switched on. Further, the light sensor may be used for the purpose of identifying the light source, as is described above.

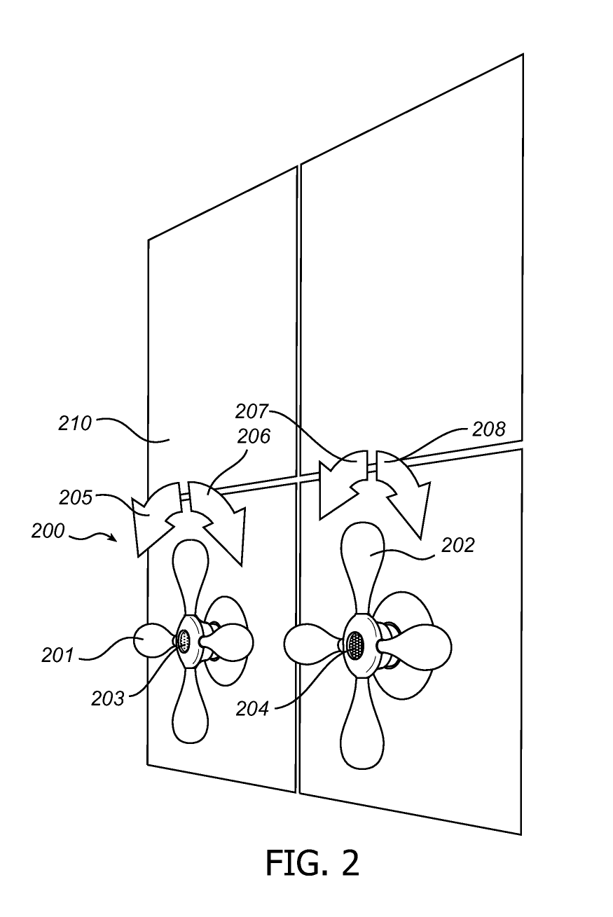

As an alternative to the light faucet described with reference to FIG. 1, another embodiment of the invention is shown in FIG. 2.

The controlling device 200 resembles a traditional faucet and comprises two knobs, or wheels, 201 and 202 for controlling the intensity and/or color temperature of light emitted by an adjustable light source. After the fashion of a traditional water faucet, in which case one of the knobs controls the flow of cold water and the other knob controls the flow of warm water, knob 201 may be used to control the portion of “cold light”, whereas knob 202 may be used to control the portion of “warm light”. Note that the notion of a portion of cold or warm light is merely introduced here for the purpose of elucidating the invention and does not relate to a spectral range of light or the like. Knobs 201 and 202 are provided with colored labels 203 and 204, such as blue and red, respectively, for indicating the relation between the respective knob and the change in color temperature brought about by changing that knob's setting.

Thus, by turning knob 201 counter-clockwise 205, the portion of “cold light” is increased, thereby increasing the intensity of light and lowering its color temperature. The opposite effect is achieved by rotating knob 201 clockwise 206. Further, by turning knob 202 counter-clockwise 207, the portion of “warm light” is increased, thereby increasing the intensity of light and increasing its color temperature. The opposite effect is achieved by rotating knob 202 clockwise 208.

Thus, the intensity of light may be derived from a sum of the position of the first knob 201 and the position of the second knob 202, whereas the light's color temperature may be derived from a ratio of the two positions or a difference of the two positions.

Device 200 further comprises means for sensing a position of the first knob 201 and a position of the second knob 202, which positions are set by the user, means for generating a control signal, means for communicating with a light source, and a power supply, such as a battery or a means for scavenging energy (not shown in FIG. 2). Device 200 may further comprise a light sensor for sensing light emitted by an adjustable light source for the purpose of activating device 200 only when the adjustable light source is switched on. Further, the light sensor may be used for the purpose of identifying the light source, as is described above.

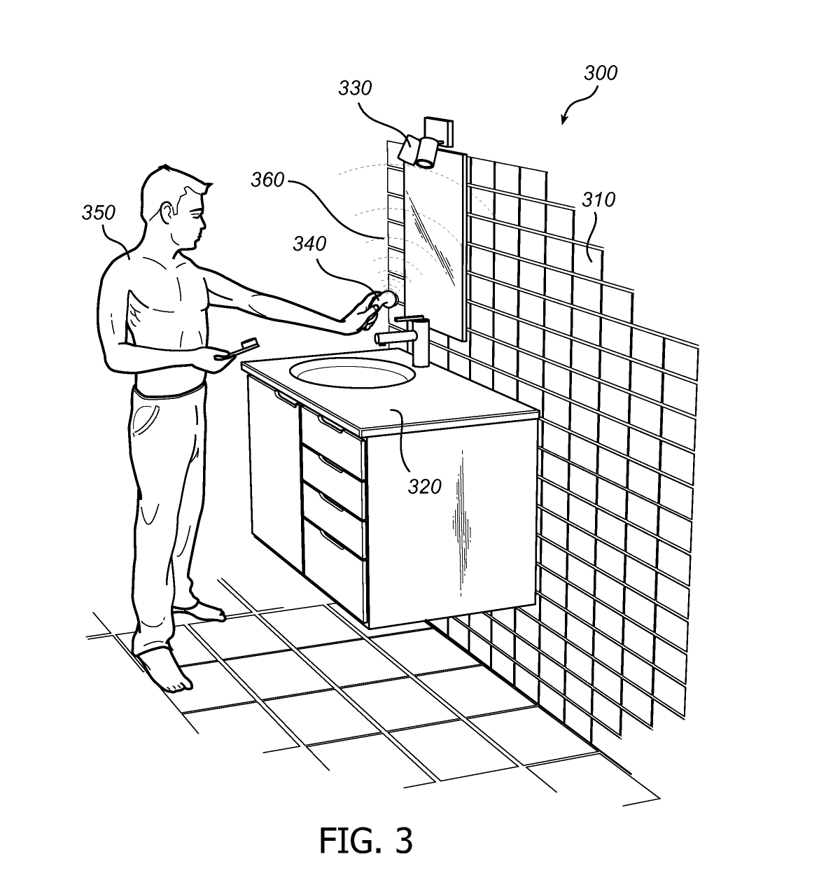

In FIG. 3, a consumer lighting application utilizing an embodiment of the invention, such as light faucet 100 described with reference to FIG. 1, is illustrated.

As an example, a part 300 of a bathroom is shown in FIG. 3, having a tile wall 310 with a sink 320 mounted to it, and a lamp 330 for illuminating the bathroom. Further, a light faucet 340 is shown, which is attached to the tile wall 310 close to the sink 320. A user 350 may use the light faucet 340 for controlling the intensity and the color temperature of light emitted by lamp 330 as described above. The control signal generated by light faucet 340 is transmitted to the lamp 330 in a wireless fashion, e.g. using radio waves 360 or infrared light 360.

The person skilled in the art realizes that the present invention is by no means limited to the embodiments described above. On the contrary, many modifications and variations are possible within the scope of the appended claims. For example, multiple faucets may be utilized for controlling a single light source or multiple light sources. Further, a single light faucet may be used for controlling multiple light sources. An embodiment of the invention may further be provided with means for controlling additional properties of light. For instance, a light faucet may comprise a color wheel, or the like, for adjusting the color of light emitted by an adjustable light source. Finally, it will be appreciated that the embodiments described above are not limited to controlling the intensity and the color temperature of light but may be used for controlling other properties of light. It will also be appreciated that the invention is not limited to the particular associations between a certain movement of the handle, or a knob, and a property of light as described above.

In conclusion, a device for controlling an intensity and a color temperature of light emitted by an adjustable light source is provided. The device resembles the well-known faucet for adjusting the flow and the temperature of water. The device comprises a user-operable handle, a lever movement of the handle being associated with the intensity and a rotational movement of the handle being associated with the color temperature, sensor means for sensing a user-set position of the handle, and means for generating, in accordance with the user-set position, a control signal for controlling the intensity and the color temperature of light emitted by the adjustable light source. An embodiment of the invention constitutes a tangible user-interface by providing control means which are well-known to consumers and which are associated with the notion of “cold” and “warm”.

1. A device for controlling an intensity and a color temperature of light emitted by an adjustable light source, the device comprising:
a user-operable handle being maneuverable through a two-dimensional space, a lever movement of the handle being associated with the intensity and the rotational movement of the handle being associated with the color temperature,
sensor means being arranged for sensing a user-set position of the handle, and
means for generating, in accordance with the user-set position, a control signal for controlling the intensity and the color temperature of light emitted by le adjustable light source.

2. The device according to claim 1, further comprising means for storing the user-set position, wherein the means for generating a control signal is further arranged for generating, when the device is activated, a control signal in accordance with the last stored user-set position.

3. The device according to claim 1, further comprising a clock, wherein the means for generating a control signal is further arranged for generating, when the device is activated, a control signal in accordance with a time of day.

4. The device according to claim 1, wherein the sensor means is arranged for sensing the user-set position using accelerometers.

5. The device according to claim 1, further comprising means for scavenging electrical energy from a movement of the handle.

6. The device according to claim 1, further comprising a suction cup (107) for attaching the device to a surface.

7. A lighting system comprising:
a controlling device according to claim 6, and
a controllable light source configured for:
receiving a control signal from the device, and
adjusting the intensity and the color temperature of emitted light in response to the received control signal.

8. A device for controlling an intensity and a color temperature of light emitted by an adjustable light source, the device comprising:
a user-operable first knob,
a user-operable second knob,
sensor means being arranged for sensing a user-set first position of the first knob and a user-set second position of the second knob, and
means for generating, in accordance with the user-set first position and second position, a control signal for controlling the intensity and the color temperature of light emitted by the adjustable light source,
wherein a sum of the first position and the second position is indicative of the desired intensity and a ratio or a difference of the first position and the second position is indicative of the desired color temperature.

9. The device according to claim 8, further comprising means for storing the first position and the second position, wherein the means for generating a control signal is further arranged for generating, when the device is activated, a control signal in accordance with the last stored positions.

10. The device according to claim 8, further comprising a clock, wherein the means for generating a control signal is further arranged for generating, when the device is activated, a control signal in accordance with a time of day.

11. The device according to claim 8, wherein the sensor means is arranged for sensing the first position and the second position using accelerometers.

12. The device according to claim 8, further comprising means for scavenging electrical energy from the first knob and the second knob.

13. The device according to claim 8, further comprising a suction cup for attaching the device to a surface.

14. A lighting system comprising:
a controlling device according to claim 13, and
a controllable light source being arranged for:
receiving a control signal from the device, and
adjusting the intensity and the color temperature of emitted light in response to the received control signal.

15. The device according to claim 1, wherein the color temperature and the light intensity are controllable with a single gestural action of moving the handle.
